(19) United States
(12) Patent Application Publication
(10) Pub. No.: US 2015/0254963 A1
(43) Pub. Date: Sep. 10, 2015

(54) VEHICLE WARNING SYSTEM

(71) Applicant: TOYOTA JIDOSHA KABUSHIKI KAISHA, Toyota-shi (JP)

(72) Inventor: Shoji KAKINUMA, Okazaki-shi (JP)

(73) Assignee: TOYOTA JIDOSHA KABUSHIKI KAISHA, Toyota-shi (JP)

(21) Appl. No.: 14/639,158

(22) Filed: Mar. 5, 2015

(30) Foreign Application Priority Data
Mar. 6, 2014 (JP) 2014-044188

(51) Int. Cl. G08B 21/24

(52) U.S. Cl. CPC G08B 21/24

(57) ABSTRACT

A vehicle warning system includes a detecting portion that is provided on each of a plurality of doors of a vehicle, and detects whether each of the doors is open, including ajar, or closed; a warning portion that warns that one of the doors is open, when it is detected by the detecting portion that at least one of the doors is open; and a storing portion that stores information indicating a door type of the door that was detected as being open by the detecting portion, at a point at which the warnings starts, from among the doors. The warning portion stops the warning and issues an additional warning of a different pattern, according to the door type stored by the storing portion, when any of the doors are opened from a closed state while the warning is being issued.

### INCORPORATION BY REFERENCE

The disclosure of Japanese Patent Application No. 2014-044188 filed on Mar. 6, 2014 including the specification, drawings and abstract is incorporated herein by reference in its entirety.

### BACKGROUND OF THE INVENTION

1. Field of the Invention

The invention relates to a vehicle warning system that issues a warning when any one of a plurality of doors of a vehicle is open (including ajar).

2. Description of Related Art

Japanese Patent Application Publication No. 2009-241859 (JP 2009-241859 A) and Japanese Patent Application Publication No. 2012-076623 (JP 2012-076623 A), for example, describe vehicle warning systems that issue a warning that a door is open, when it is detected that any one of a plurality of doors of a vehicle is open.

However, if a warning that one of the doors of the vehicle is open is issued, the warning will continue to be issued for a certain period of time unless the open state of the door is corrected, i.e., unless the open door is closed, which may be problematic. For example, when a warning that one of the doors of the vehicle is open (or ajar) is issued, the user may have opened the door to check a meter in the vehicle cabin. However, the warning will continue to be issued for a certain period of time unless all of the doors are closed. Therefore, even though the user is already aware of the warning so there is no need for the warning, the warning is unable to be immediately stopped, which may be irritating to the user.

Also, in a vehicle in which there is no indication or the like indicating the door that is open (or ajar), it may not be possible to ascertain which door is open (or ajar). Therefore, even though a warning is issued, it may not be possible to immediately correct the situation (i.e., the situation in which one of the doors is open).

### SUMMARY OF THE INVENTION

Thus, the invention provides a vehicle warning system which, when warning that any one of a plurality of doors of a vehicle is open, including ajar, is capable of preventing the warning from being continued, and prompting a user to promptly correct a situation in which one of the doors is open, in a situation in which the warning is unnecessary, such as when the user is already aware of the warning.

One aspect of the invention relates to a vehicle warning system. This vehicle warning system includes a detecting portion that is provided on each of a plurality of doors of a vehicle, and detects whether each of the doors is open, including ajar, or closed; a warning portion that warns that one of the doors is open, when it is detected by the detecting portion that at least one of the doors is open; and a storing portion that stores information indicating a door type of the door that is detected as being open by the detecting portion, at a point at which the warnings starts, from among the doors. The warning portion stops the warning and issues an additional warning of a different pattern, according to the door type stored by the storing portion, when any of the doors are opened from a closed state while the warning is being issued.

According to this aspect of the invention, it is possible to provide a vehicle warning system which, when warning that any one of a plurality of doors of a vehicle is open, including ajar, is capable of preventing the warning from being continued, and prompting a user to promptly correct a situation in which one of the doors is open, in a situation in which the warning is unnecessary, such as when the user is already aware of the warning.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram of the structure of a vehicle warning system according to one example embodiment of the invention;

FIG. 2 is a view illustrating smart lock (unlock) control;

FIG. 3 is a flowchart illustrating one example of a routine executed by the vehicle warning system (smart ECU); and

FIG. 4 is a flowchart illustrating a failure detection operation of a door courtesy switch with the vehicle warning system.

### DETAILED DESCRIPTION OF EMBODIMENTS

Hereinafter, example embodiments of the invention will be described with reference to the drawings.

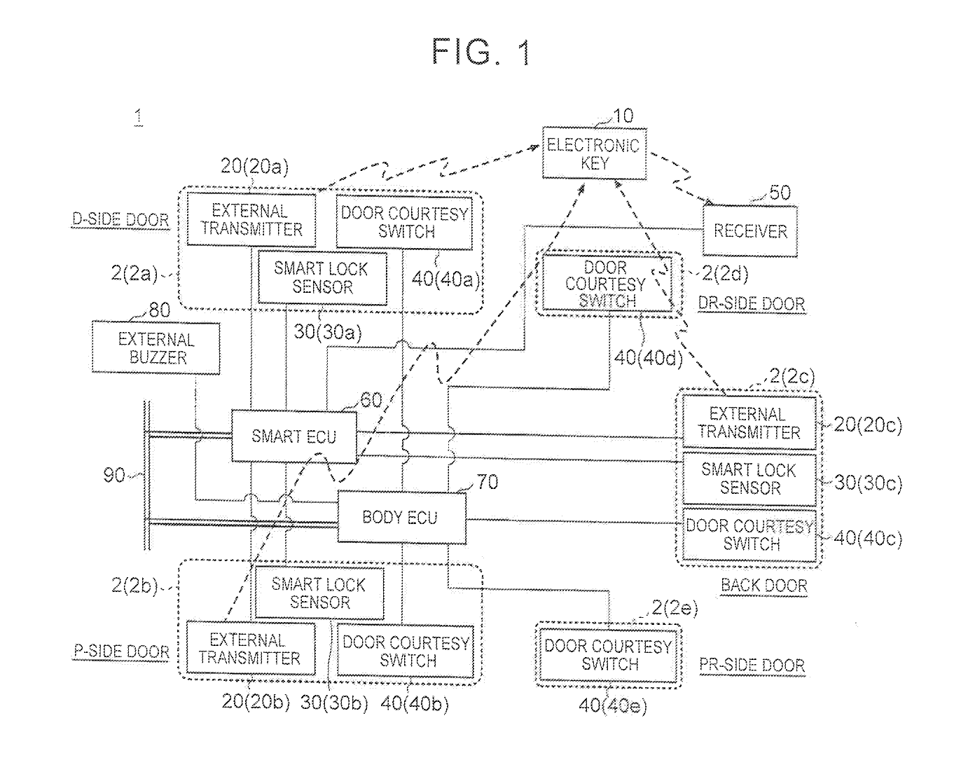

FIG. 1 is a block diagram of the structure of a vehicle warning system 1 according to one example embodiment. The vehicle warning system 1 issues a warning when at least one of a plurality of doors of a vehicle is open (including ajar), when a smart lock operation that will be described later is performed. This vehicle has a plurality of (five) doors 2 (2a to 2e). More specifically, the vehicle has a driver side door 2a (D-side door), a passenger side door 2b (P-side door), a door 2c (back door) that accesses a trunk, a rear driver side door 2d (DR-side door), and a rear passenger side door 2e (PR-side door).

The vehicle warning system 1 includes an electronic key 10, external transmitters 20, smart lock sensors 30, door courtesy switches 40, a receiver 50, a smart ECU 60, a body ECU 70, and an external buzzer 80 and the like.

The electronic key 10 is a portable authenticating terminal that has a wireless communication function. The electronic key 10 outputs a unique ID code that is stored internally to the vehicle side (i.e., the receiver 50), and the ID code is verified by the smart ECU 60. If the ID code is authenticated by being verified, smart entry control (smart lock (unlock) control) according to the electronic key 10 is executed by the smart ECU 60.

The electronic key 10 is configured to be able to receive a request signal output from the smart ECU 60, via the external transmitters 20 (20a to 20c) provided in the doors 2a to 2c of the vehicle. Also, the electronic key 10 outputs a response signal corresponding to the request signal to the receiver 50. The response signal includes information pertaining to the unique ID code stored in the electronic key 10.

The external transmitters 20 (20a to 20c) are radio wave transmitting means that are provided corresponding to the doors 2a to 2c (the D-side door, the P-side door, and the back door), and transmit the request signal output from the smart ECU 60 as radio waves. The range of the request signal transmitted by the external transmitters 20a to 20c is approximately 1.0 meter, for example. An external detection area of the electronic key 10, i.e., an external detection area for ID code verification via bidirectional communication between the electronic key 10 and the smart ECU 60, is created by the area reached by the transmitted request signal. The external transmitters 20a to 20c may be communicatively connected to the smart ECU 60 by an onboard network such as LIN (Local Interconnect Network), for example.

The smart lock sensors 30 (30a to 30c) are detecting means for detecting a smart lock (unlock) operation by a user, that are provided corresponding to the doors 2a to 2c. A smart lock (unlock) operation is an operation that locks (unlocks) the vehicle, based on ID verification via bidirectional communication between the electronic key 10 and the smart ECU 60, by a user carrying the electronic key 10 corresponding to the vehicle performing an operational input, such as touching one of the smart lock sensors 30. The smart lock sensors 30a to 30c are communicatively connected to the smart ECU 60 by an onboard network such as LIN, for example, and a signal corresponding to the operational input by the user (i.e., an operation signal) is output to the smart ECU 60.

The smart lock sensors 30 may also be provided for the door 2d (i.e., the DR-side door) and the door 2e (i.e., the PR-side door), in addition to the doors 2a to 2c. Also, the smart lock sensors 30 may be provided for only the door 2a (i.e., the D-side door) and the door 2b (the P-side door), and not be provided for the door 2c (i.e., the back door). That is, it is sufficient that at least one of smart lock sensors 30 be provided corresponding to any one of the doors 2a to 2c. Also, the external transmitter 20 described above is preferably provided corresponding to the doors 2 (any of 2a to 2e) provided with the smart lock sensor 30. Also, a smart lock switch may be provided instead of a smart lock sensor.

The door courtesy switches 40 (40a to 40e) are detecting means for detecting an open/closed state of the doors 2a to 2e (i.e., whether each of the doors is open, including ajar, or closed), that are provided corresponding to the doors 2a to 2e. The door courtesy switches 40a to 40e are arranged on mounting portions of the doors 2a to 2e. These door courtesy switches 40a to 40e are pushed in and output a door-closed signal in response to the doors 2a to 2c being closed, and are released and output a door-open signal when the doors 2a to 2e are opened. The door courtesy switches 40a to 40e also output a door-open signal when the doors 2a to 2e are so-called ajar (i.e., not entirely shut). The door courtesy switches 40a to 40e are communicatively connected to the body ECU 70 by an onboard network such as LIN, for example, and the door-closed signal and the door-open signal are output to the body ECU 70.

The receiver 50 is radio wave receiving means for receiving the response signal output from the electronic key 10. The receiver 50 is communicatively connected to the smart ECU 60 by an onboard network such as LIN, for example, and outputs the received response signal to the smart ECU 60.

The smart ECU 60 is controlling means for verifying the ID code via bidirectional communication with the electronic key 10, and performing smart entry control (smart lock (unlock) control) based on the verification result. The smart lock (unlock) control initiates bidirectional communication with the electronic key 10 in response to a smart lock operation (an operational input to one of the smart lock sensors 30a to 30c) by the user, and performs ID verification of the electronic key 10, and then locks (unlocks) the doors 2a to 2e of the vehicle according to the verification result.

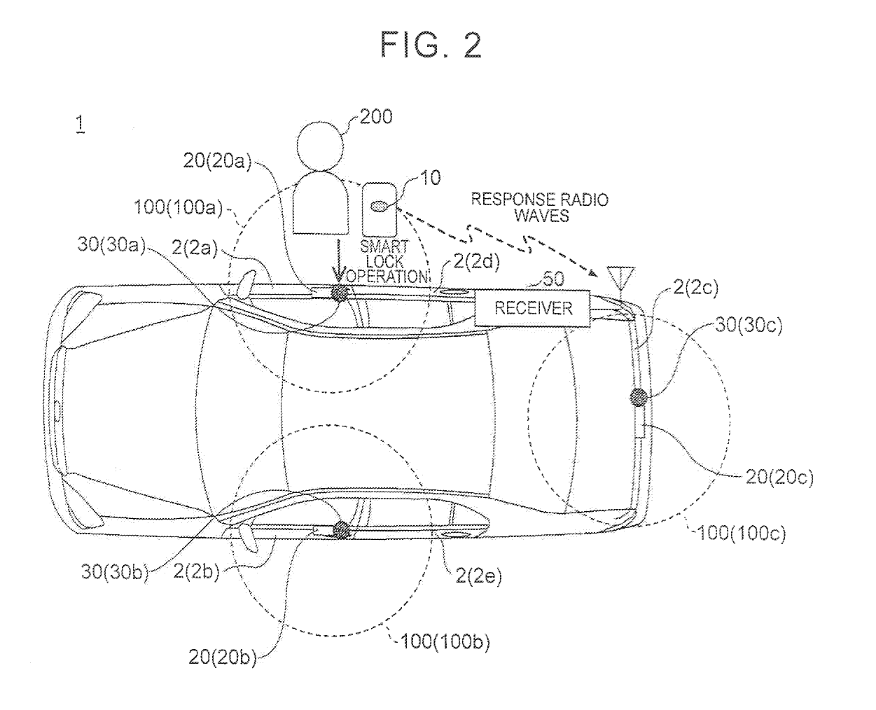

Smart entry control (smart lock (unlock) control) in which the smart ECU 60 locks (unlocks) the doors 2a to 2e according to a smart lock (unlock) operation by the user will now be described with reference to FIG. 2.

FIG. 2 is a view illustrating smart lock (unlock) control. FIG. 2 is a plan view of the vehicle including the vehicle warning system 1 according to the example embodiment, and shows one arrangement of the external transmitters 20a to 20c and the smart lock sensors 30a to 30c that are provided one each for each of the doors 2a to 2c. For example, the external transmitters 20a to 20c and the smart lock sensors 30a to 30c may be integrally provided with door handles of the doors 2a to 2c. FIG. 2 also shows one arrangement of the receiver 50 in which the receiver 50 is provided on a vehicle rear portion. In addition, FIG. 2 shows scenario in which a user 200 carrying the electronic key 10 approaches the door 2a and performs a smart lock operation with respect to the smart lock sensor 30a. Hereinafter, the flow (1) to (6)) of the smart lock control executed by the smart ECU 60 in response to the smart lock operation by the user 200 will be described.

(1)

When a smart lock operation (i.e., an operational input corresponding thereto) of the smart lock sensor 30a is performed by the user 200, the smart lock sensor 30a outputs an operation signal to the smart ECU 60.

(2)

In response to the operation signal from the smart lock sensor 30a, the smart ECU 60 outputs a request signal to the external transmitter 20a. An external detection area 100a of the electronic key 10 is then created by a signal being transmitted as radio waves from the external transmitter 20a.

(3)

The electronic key 10 (carried by user 200) that is inside the external detection area 100a receives the request signal, and transmits (wirelessly) a response signal (response radio waves) that includes the unique ID code to the receiver 50, in response to the request signal.

(4)

The receiver 50 outputs the received response signal to the smart ECU 60, and the smart ECU 60 that has received the response signal verifies the ID code (i.e., verifies the electronic key 10). The electronic key 10 may be verified according to whether the ID code in the response signal matches an ID code stored in the smart ECU 60 in advance, for example.

(5)

If the electronic key 10 is successfully verified, the smart ECU 60 locks (unlocks) the doors 2a to 2e. More specifically, the smart ECU 60 outputs a lock operation request signal (unlock operation request signal) to the body ECU 70 that will perform control to lock/unlock the doors 2a to 2e. The smart ECU 60 and the body ECU 70 are communicatively connected together by a CAN (Controller Area Network) 90 that is an onboard network.

(6)

The body ECU 70 operates an actuator (such as a door lock motor, for example) that locks (unlocks) the doors 2a to 2e, in response to the lock operation request signal (unlock operation request signal) from the smart ECU 60.

In this way, the smart ECU 60 performs smart entry control (smart lock (unlock) control) and locks (unlocks) the doors 2a to 2e, in response to the smart lock (unlock) operation by the user 200.

In the description above, the user 200 performs a smart lock operation with respect to the smart lock sensor 30a provided on the door 2a (i.e., the D-side door), but similarly, the user 200 may perform a smart lock (unlock) operation with respect to the smart lock sensor 30b provided on the door 2b (i.e., the P-side door), or the smart lock sensor 30c provided on the door 2c (i.e., the back door). At this time, similarly an external detection area 100b or an external detection area 100c is created by a request signal transmitted as radio waves from the external transmitter 20b provided in the door 2b or the external transmitter 20c provided in the door 2c.

Also, the smart ECU 60 issues a warning to the user by the external buzzer 80 when a smart lock operation has been performed by the user and any one of the doors 2a to 2e of the vehicle is open. That is, if even one of the doors 2a to 2e is open (including ajar), none of the doors 2a to 2e will be able to be locked, so the smart ECU 60 issues a warning to notify the user that at least one of the doors 2a to 2e is open, including ajar. More specifically, if an operation signal is received from any of the smart lock sensors 30a to 30c, the smart ECU 60 determines the open/closed state of each door 2a to 2c based on a signal (a door-open signal or a door-closed signal) output from the door courtesy switches 40a to 40e provided corresponding to the doors 2a to 2c. Here, if even one of the doors 2a to 2e is open, including ajar, the smart ECU 60 transmits a buzzer operation signal to the body ECU 70 to drive the external buzzer 80 via the body ECU 70. The smart ECU 60 then notifies (warns) the user that at least one of the doors 2a to 2e is open, by a sound emitted from the external buzzer 80. Also, when a predetermined period of time (e.g., five seconds) has passed from the start of the warning, the smart ECU 60 outputs a buzzer stop signal to the body ECU 70 to stop driving the external buzzer 80 via the body ECU 70, thus stopping the warning. Therefore, in a case such as when a smart lock operation is performed while one of the doors 2a to 2e is ajar, for example, the user is able to be made aware of the fact that at least one of the doors 2a to 2e is open (or ajar) by the warning.

The smart ECU 60 is able to receive, via the CAN 90, signals (door-open signals or door-closed signals) output from the door courtesy switches 40a to 40e, which are output regularly to the CAN 90 by the body ECU 70.

The body ECU 70 is controlling means for performing lock/unlock control of the doors 2a to 2e. The body ECU 70 more specifically operates an actuator that locks (unlocks) the doors 2a to 2e, in response to the lock operation request signal (unlock operation request signal) from the smart ECU 60, as described above.

Also, the body ECU 70 is also controlling means for performing driving control of the external buzzer 80, and drives the external buzzer 80 in a predetermined pattern in response to the buzzer operation signal output from the smart ECU 60. Also, the body ECU 70 also stops driving the external buzzer 80 in response to a buzzer stop signal output from the smart ECU 60.

The smart ECU 60 and the body ECU 70 may each be formed by a microcomputer, and may execute the various control processes described above by executing various programs stored in ROM on a CPU. Also, the functions of the smart ECU 60 and the body ECU 70 may be realized by suitable hardware, software, firmware, or a combination of these. Also, some or all of the functions of the smart ECU 60 and the body ECU 70 may be executed by another ECU. Further, the smart ECU 60 and the body ECU 70 may execute some or all of the functions of another ECU. For example, some or all of the functions of the body ECU 70 may be executed by the smart ECU 60, or some or all of the functions of the smart ECU 60 may be executed by the body ECU 70.

The external buzzer 80 is warning means for issuing a warning to the user by a sound (an electronic sound). The external buzzer 80 is mounted outside the vehicle cabin, and is configured to be able to emit a sound loud enough to be easily recognized by a user outside the vehicle cabin. Moreover, the external buzzer 80 is arranged in a position where a user outside the vehicle cabin is able to easily recognize the emitted sound. The external buzzer 80 sounds a continuous sound such as a long continuous beep for a predetermined period of time (such as five seconds) when a drive signal for the warning described above is received from the body ECU 70.

Next, characteristic processes performed by the vehicle warning system 1 (the smart ECU 60) according to the example embodiment will be described. More specifically, an additional warning routine that is executed in addition after a routine for warning the user that one of the doors 2a to 2e is open when the user performs a smart lock operation described above will be described.

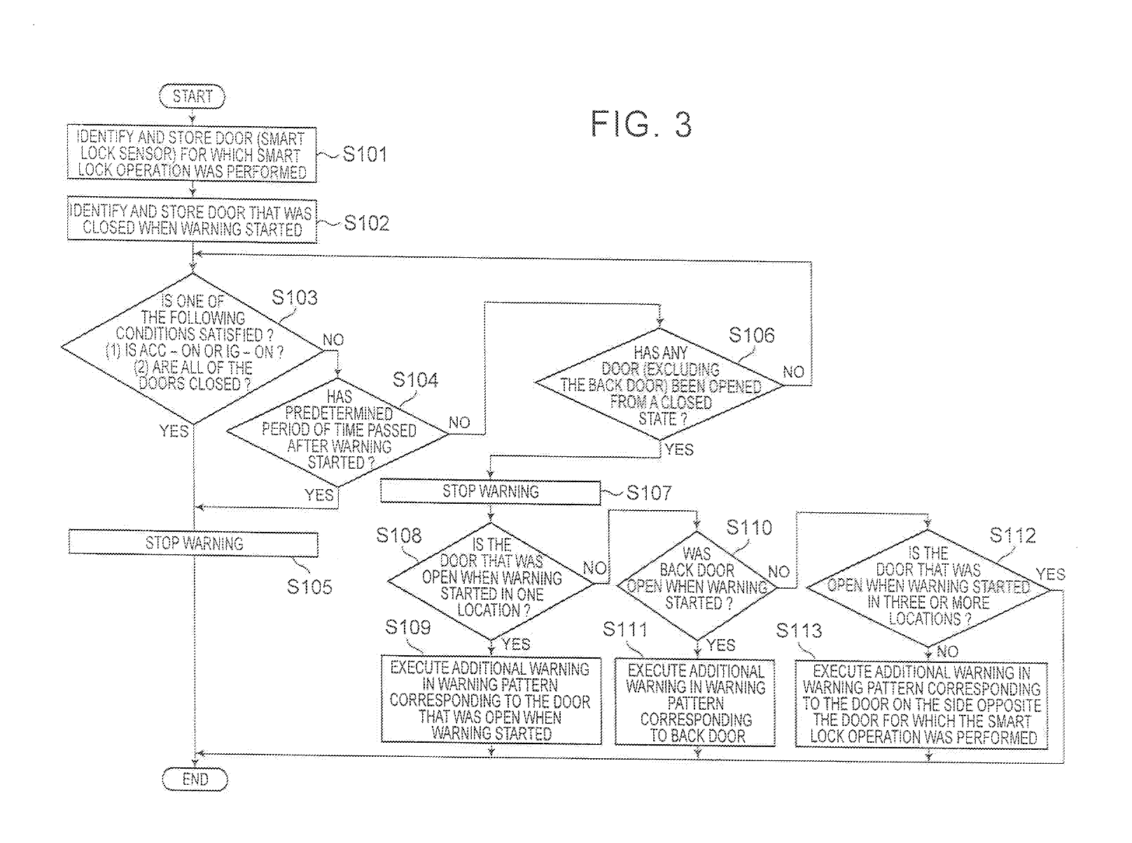

FIG. 3 is a flowchart illustrating one example of a routine (the additional warning routine) performed by the vehicle warning system 1 (the smart ECU 60) according to this example embodiment. The flow is executed each time the external buzzer 80 is driven to warn the user that doors 2a to 2e are open when the user performs a smart lock operation. The smart lock control by the smart ECU 60 is able to be executed at least when a door 2 (any one of 2a to 2c) provided with the smart lock sensor 30 (any one of 30a to 30c) on which the smart lock operation is performed, is closed. That is, the smart lock control by the smart ECU 60 is not executed when a door 2 (any one of 2a to 2c) provided with the smart lock sensor 30 (any one of 30a to 30c) on which the smart lock operation is performed, is open (or ajar).

Referring to FIG. 3, in step S101, the door (i.e., the door type (D-side door, P-side door, DR-side door, PR-side door, or back door, respectively)) on which the smart lock operation is performed, from among the doors 2a to 2c, is stored in internal memory or the like, based on the operation signal input from the smart lock sensor 30 (any one of 30a to 30c).

Then in step S102, the door (type of door) that was open, including ajar, when the warning started (when the smart lock operation was performed) is stored in internal memory or the like, based on the signals from the door courtesy switches 40a to 40e.

Continuing on, in step S103, it is determined whether one of two conditions, i.e., (1) whether an accessories switch is on (i.e., ACC—ON) or an ignition switch is on (i.e., IG—ON), and (2) whether all of the doors 2a to 2e are closed, is satisfied. That is, when the vehicle power supply is ON, it is highly likely that the user is getting into the vehicle cabin and will actually use the vehicle, so the situation is one in which the warning indicating that the doors are open when the smart lock operation is being performed will not continue. Also, when all of the doors 2a to 2e are closed, the condition that one of the doors 2a to 2e be open, which is a prerequisite for the warning, is corrected, so the situation is not one in which the warning will continue. Therefore, in this step it is determined whether (1) or (2) as a warning stopping condition is satisfied. If the determining condition (i.e., the warning stopping condition) is satisfied, the process proceeds on to step S105. On the other hand, if the determining condition (i.e., the warning stopping condition) is not satisfied, the process proceeds on to step S104.

In step S104, whether a predetermined period of time T (e.g., five seconds) has passed after the warning started is then determined. If the predetermined period of time T has passed, the process proceeds on to step S105. If the predetermined period of time T has not passed, the process proceeds on to step S106.

In step S105, the warning is stopped. That is, if the warning stopping condition (1) or (2) is satisfied (i.e., if the condition in step S103 is satisfied), the warning is stopped. Also, if the predetermined period of time T has passed after the warning started (i.e., if the condition in step S104 is satisfied), it is determined that the purpose of notifying the user by the warning has been fulfilled, so the warning is stopped.

On the other hand, in step S106, it is determined whether any of the doors 2a to 2e, excluding the door 2c (i.e., the back door), were opened from a closed state. That is, in some cases, the user may open the door for which the smart lock operation is performed, or a neighboring door, and perform an action such as check a meter display in order to correct a situation (i.e., to close the open door), in response to the warning. Therefore, in this step, it is determined whether an action (a corrective action) in an attempt to correct the situation has been performed by the user. If a door, excluding the door 2c, was opened from a closed state, the process proceeds on to step S107, and if a door, excluding the door 2c, was not opened from a closed state, the process returns to step S103. That is, for the predetermined period of time T after the warning starts, the smart ECU 60 repeatedly determines whether the warning stopping condition is satisfied (step S103), and whether a corrective action has been performed by the user (step S106).

In step S107, the warning is stopped in response to a corrective action by the user. As a result, when the user performs a corrective action such that it seems that the user is already aware that at least one of the doors 2a to 2e is open, the warning can be prevented from being continued. Therefore, the user will not be irritated by the warning being continued.

In step S106, the reason for excluding a case in which the user opens the closed door 2c (i.e., the back door) is because there is a possibility that the back door is opened by a fellow occupant other than the user in order to load or unload baggage. However, in step S106, whether any door, including the door 2c (i.e., the back door) as well, has been opened from a closed state may be determined. That is, the action of opening the door 2c (i.e., the back door) may also be regarded as a corrective action.

Continuing on, in step S108, it is determined whether a door that was open when the warning started is in just one location, based on information stored in the internal memory in step S102. If the door that was open when the warning started is in just one location, the process proceeds on to step S109. On the other hand, if the door that was open when the warning started is not just in one location (i.e., if a plurality of doors were open), the process proceeds on to step S110.

In step S109, an additional warning is executed in a warning pattern corresponding to the door that was open when the warning started, and then this cycle of the routine ends. That is, a warning pattern that is different for each door 2a to 2e is set in advance, and the external buzzer 80 is driven such that an additional warning is executed in the warning pattern corresponding to the door that was open when the warning started. One example of a warning pattern corresponding to each door is given below. For example, with the warning pattern corresponding to the door 2a (i.e., the D-side door), the external buzzer 80 sounds three short beeps. Also, with the warning pattern corresponding to the door 2b (i.e., the P-side door), the external buzzer 80 sounds five short beeps. Also, with the warning pattern corresponding to the door 2c (i.e., the back door), the external buzzer 80 sounds short intermittent beeps for several seconds (i.e., two to three seconds). Also, with the warning pattern corresponding to the door 2d (i.e., the DR-side door), the external buzzer 80 sounds three long beeps. Also, with the warning pattern corresponding to the door 2e (i.e., the PR-side door), the external buzzer 80 sounds five long beeps. As a result, the user is able to ascertain which of the doors is open (or ajar) by distinguishing the additional warnings. Therefore, a situation in which a door is open (or ajar) is able to be quickly corrected.

For the additional warning, information about the warning pattern sounded by the external buzzer 80 is included in the buzzer operation signal output from the smart ECU 60 to the body ECU 70.

On the other hand, in step S110, it is then determined whether the door 2c (i.e., the back door) was open when the warning started, based on information stored in the internal memory or the like in step S102. That is, when a plurality of doors were open when the warning started, it is determined whether the door 2c (i.e., the back door) is one of those doors. If the door 2c (i.e., the back door) is one of the doors that were open when the warning started, the process proceeds on to step S111. On the other hand, if the door 2c (i.e., the back door) is not one of the doors that were open when the warning started, the process proceeds on to step S112.

In step S111, an additional warning in the warning pattern corresponding to the door 2c (i.e., the back door) is executed, and then this cycle of the routine ends. That is, it is not easy for the user to discern whether the door 2c (i.e., the back door) that is a door that accesses the trunk is ajar, due to the position and shape and the like of the door. Therefore, if there are a plurality of doors that were open when the warning started, and the door 2c (i.e., the back door) is one of those doors, the additional warning in the warning pattern corresponding to the door 2c (i.e., the back door) is executed. As a result, the user is easily able to recognize that the door 2c (i.e., the back door), which is a door that is difficult to recognize when it is ajar, is ajar, so a situation in which the door 2c is open (or ajar) can be promptly corrected.

On the other hand, in step S112, it is then determined whether the door that was open when the warning started was in three or more locations, based on the information stored in the internal memory and the like in step S102. If the door that was open when the warning started was not in three or more locations (i.e., was in two locations), the process proceeds on to step S113. On the other hand, if the door that was open when the warning started was in three or more locations, this cycle of the routine ends without executing an additional warning. This is because it is thought that when the door that was open when the warning started is in three or more locations, it is highly likely that the smart lock operation was performed prematurely while the doors were still open, so there is no need to execute the additional warning. Further, when the door that was open when the warning started is in three or more locations, the door closest to the door 2 (any one of 2a to 2c) on which the smart lock operation was performed is also open (or ajar), so it is possible to easily ascertain that there is a door that is ajar.

In step S113, an additional warning in the warning pattern corresponding to the door on the side opposite the door 2 (either 2a or 2b) on which the smart lock operation was performed is executed, and then this cycle of the routine ends. For example, when a smart lock operation was performed on the smart lock sensor 30a provided on the door 2a (i.e., the D-side door), an additional warning is executed in the warning pattern corresponding to the door positioned on the passenger side, which is the side opposite the driver side, from among the doors that were open when the warning started. Also, when a smart lock operation was performed on the smart lock sensor 30b provided on the door 2b (i.e., the P-side door), an additional warning is executed in the warning pattern corresponding to the door positioned on the driver side, which is the side opposite the passenger side, from among the doors that were open when the warning started. This is because it is difficult to ascertain whether the door positioned on the side opposite (i.e., the passenger side with respect to the driver side, or the driver side with respect to the passenger side) the door 2 (either 2a or 2b) on which the smart lock operation was performed is open (or ajar).

When a smart lock operation was performed on the smart lock sensor 30c provided on the door 2c (i.e., the back door), this cycle of the routine may end without executing an additional warning. This is because it is thought to be relatively easy to ascertain both the state of the driver side door and the state of the passenger side door from the area around the door 2c (i.e., the back door).

Also, when the door positioned on the side opposite the door 2 (either 2a or 2b) on which the smart lock operation was performed, from among the doors that were open when the warning started, is in two locations, the determination as to which of the additional warnings in the warning patterns corresponding to the doors is to be executed may be made in advance. For example, when a smart lock operation was performed with the door 2a (i.e., the D-side door), and the door 2b (i.e., the P-side door) and the door 2c (i.e., the PR-side door) were both open when the warning started, the additional warning in the warning pattern corresponding to the door 2b (i.e., the P-side door) may be set in advance as the additional warning to be issued. Also, when a smart lock operation was performed with the door 2b (i.e., the P-side door), and both the door 2a (i.e., the D-side door) and the door 2d (i.e., the DR-side door) were open when the warning started, the additional warning in the warning pattern corresponding to the door 2a (i.e., the D-side door) may be set in advance as the additional warning to be issued.

In this way, the vehicle warning system 3 stops the warning when any door (excluding the back door), from among the doors 2a to 2e, is opened from a closed state while the warning is being executed. As a result, when the user opens one of the doors 2a to 2e from a closed state while the warning is being issued, and is thus seemingly already aware of the fact that at least one of the doors 2a to 2c is open, the warning is able to be prevented from continuing. Also, because the warning does not continue, the user will not feel irritated.

Further, in addition to stopping the warning as described above, the vehicle warning system 1 issues additional warnings of different patterns, according to the type of door that was open when the warning started. More specifically, when the door that was open when the warning started is just one door, the vehicle warning system 1 issues an additional warning in the warning pattern corresponding to the door that was open when the warning started, from among the warning patterns set in advance that correspond to the doors 2a to 2e. Also, when the door that was open when the warning started is a plurality of doors, and the door 2c (i.e., the back door) is one of those doors, an additional warning is issued in the warning pattern corresponding to the door 2c (i.e., the back door). Also, when the door that was open when the warning started is equal to or greater than a predetermined number (three) of doors, and the door 2c (i.e., the back door) is not one of those doors, an additional warning is not issued. Also, that was open when the warning started is a plurality of doors and the number of those doors is fewer than a predetermined number (three), and the door 2c (i.e., the back door) is not one of those doors, an additional warning is issued in the warning pattern corresponding to the door positioned on the side opposite the door for which the smart lock operation was performed. As a result, the user is able to easily ascertain which door is open (or ajar), and is thus able to promptly correct a situation in which the door 2c is open (or ajar).

Next, a failure detection method for the door courtesy switches 40 (40a to 40e) used in the vehicle warning system 1 according to this example embodiment will be described.

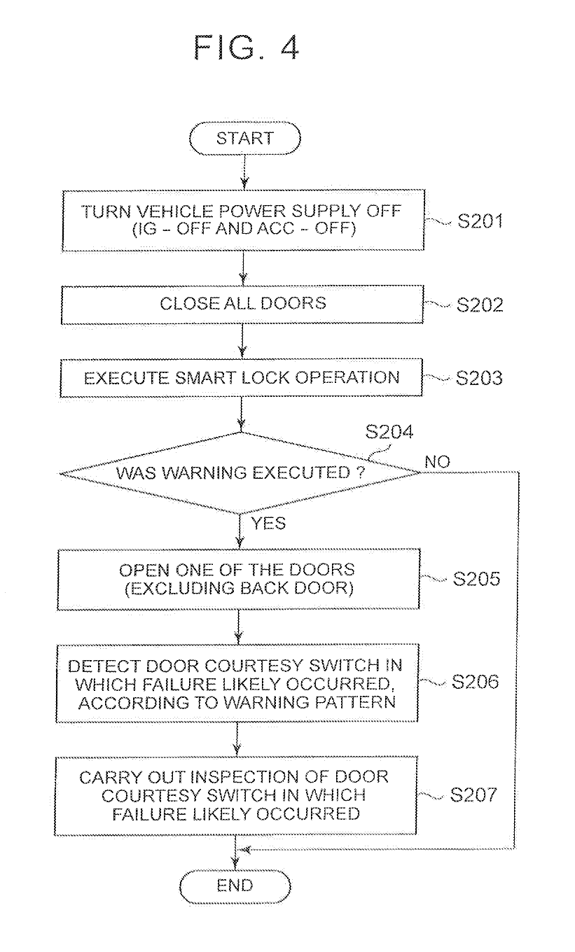

FIG. 4 is a flowchart illustrating a failure detection operation of a door courtesy switch used in the vehicle warning system 1.

Referring to FIG. 4, in step S201, an operator turns the power supply of the vehicle off (i.e., turns IG—OFF and ACC—OFF).

Then in step S202, the operator closes all of the doors.

Next, in step S203, the operator executes a smart lock operation. At this time, the door 2 for which the smart lock operation is performed is preferably the door 2a (i.e., the D-side door) or the door 2b (i.e., the P-side door). This is to identify the range of door courtesy switches that may be failing from among the door courtesy switches 40a to 40e, when two of the door courtesy switches 40 are failing, as will be described later.

Continuing on, in step S204, the operator determines whether a warning has been executed. If a warning has been executed, the process proceeds on to step S205. On the other hand, if a warning has not been executed, the possibility that there is a failure in one of the door courtesy switches 40a to 40e is low, so this failure detection operation ends.

In step S205, the operator opens one of the doors (excluding the door 2c (i.e., the back door)), from among the doors 2a to 2e while the warning is being executed. As a result, the warning by the vehicle warning system 1 is stopped, and an additional warning is executed according to the door 2 (any of 2a to 2e) that was open when the warning started, as described above.

Then, in step S206, the operator identifies the door courtesy switch that may be failing, according to the warning pattern of the additional warning. That is, in step S202, the warning by the vehicle warning system 1 is being executed even though all of the doors are closed, so it is highly likely that a failure is occurring in one of the door courtesy switches 40a to 40e, and the door-closed signal is not being output properly. Therefore, the operator is able to detect the door courtesy switch 40 (any of 40a to 40e) that is failing, according to the different warning patterns that correspond to the doors 2a to 2e.

More specifically, when only one of the door courtesy switches 40 is failing, the operator is able to directly identify the door courtesy switch 40 (any one of 40a to 40e) that is likely failing from the warning pattern.

Also, when a plurality of the door courtesy switches 40 are failing and the door courtesy switch 40c provided on the door 2c (i.e., the back door) is one of them, an additional warning is executed in the warning pattern corresponding to the door 2c (i.e., the back door). As a result, the operator is able to at least identify a failure in the door courtesy switch 40c.

Also, when three of the door courtesy switches 40 are failing and the door courtesy switch 40c provided on the door 2c (i.e., the back door) is not failing, an additional warning is not executed. As a result, the operator is able to identify failures in all three of the door courtesy switches, excluding the door courtesy switch 40 (either 40a or 40b) provided on the door 2 (either 2a or 2b) for which the smart lock operation was performed, and the door courtesy switch 40c provided on the door 2c (i.e., the back door), from among the door courtesy switches 40a to 40e.

Also, when two of the door courtesy switches 40 are failing and the door courtesy switch 40c corresponding to the door 2c (i.e., the back door) is not failing, an additional warning is executed in the warning pattern corresponding to the door positioned on the side opposite the door for which the smart lock operation was performed. As a result, the operator is able to identify at least one of the two door courtesy switches that are failing.

Continuing on, in step S207, the operator removes the door courtesy switch in which the failure was detected, carries out a detailed inspection, and finishes the work.

In this way, by using the vehicle warning system 1 according to the example embodiment, it is possible to detect a failure in the door courtesy switches 40a to 40e while they are on the vehicle. As a result, the inspection work of the door courtesy switches 40a to 40e is able to be simplified.

A failure diagnostic mode may be provided in the vehicle warning system 1 (i.e., the smart ECU 60). Also, failure detection of a door courtesy switch may be performed by issuing an additional warning in the warning pattern corresponding to the door provided with the door courtesy switch that is failing, based on a past warning history. That is, if the smart ECU 60 is configured to be able to store a past warning history, and there is a warning pattern that has been continuously sounding recently, for example, in this history, it is highly likely that there a failure in the door courtesy switch 40 provided in the door 2 corresponding to this warning pattern. Therefore, failure detection for the door courtesy switches 40 may be performed by switching the vehicle warning system 1 to the failure diagnostic mode, and automatically issuing an additional warning in the warning pattern corresponding to the door 2 provided with the door courtesy switch that is likely failing according to the past warning history. The switch of the vehicle warning system 1 (i.e., the smart ECU 60) to the failure diagnostic mode may be performed according to a predetermined operation with respect to a wireless lock operating button provided on the electronic key 10 or the like, for example.

While an example embodiment of the invention has been described in detail, the invention is not limited to this example embodiment. That is, various modifications and changes are possible without departing from the scope of the invention described in the claims.

For example, in the example embodiment described above, the vehicle warning system 1 is provided in a vehicle with five doors, i.e., two driver side doors, two passenger side doors, and one back door, but the vehicle warning system 1 may also be applied with the same operation and effects to a vehicle with any suitable door configuration.

Also, in the example embodiment described above, the vehicle warning system 1 executes routines for warnings and additional warnings when a smart lock operation is performed, but the vehicle warning system 1 may also execute similar routines for warnings and additional warnings when another lock operation is performed. For example, the vehicle warning system 1 may execute similar routines for warnings and additional warnings when a lock operation is performed with a mechanical key or when a wireless lock operation is performed by operating a wireless lock button provided on the electronic key 10. In this case as well, operation and effects similar to those of the example embodiment described above are able to be obtained.

Also, in the example embodiment described above, the vehicle warning system 1 issues warning and additional warnings with the external buzzer 80, but warnings and additional warnings may also be issued by means for generating another sound, such as a horn provided in the vehicle, for example.

Further, the external buzzer 80 in the example embodiment described above may include two external buzzers, one provided on the driver side and one provided on the passenger side. As a result, the external buzzer 80 on the side where the door corresponding to the warning pattern of the additional warning is positioned is able to be operated, so the user is able to intuitively ascertain the position of the door that is open (or ajar).

Also, in the example embodiment described above, the warnings and additional warnings are issued by the sound of the external buzzer 80, but warnings and additional warnings may also be issued by another method. For example, warnings and additional warnings may also be issued by direction indicator lamps provided on the vehicle. The direction indicator lamps are provided on both the left and right (i.e., on the driver side and the passenger side) of the vehicle. Therefore, when there is an additional warning, the direction indicator lamp on the driver side may be turned on (or turned off) for the doors (i.e., the doors 2a and 2d) on the driver side, and the direction indicator lamp on the passenger side may be turned on (or turned off) for the doors (i.e., the doors 2b and 2e) on the passenger side. Also, both the left and right direction indicator lamps (on the driver side and on the passenger side) may be turned on (or turned off) for the door 2c (i.e., the back door). As a result, the driver is able to quickly ascertain the position of a door that is open (or ajar) visually, and is thus able to promptly correct the situation (i.e., the situation in which at least one of the doors 2a to 2e is open). An additional warning by the direction indicator lamps may also be used together with the additional warning by the sound of the external buzzer 80 in the example embodiment described above. As a result, it is even easier to ascertain the position of a door that is open (or ajar), so the situation (i.e., the situation in which at least one of the doors 2a to 2e is open) is able to be corrected even faster.

Further, in addition to the additional warning in the example embodiment described above, a door that was open (or ajar) when the warning started may be specifically displayed on a combination meter or the like in the vehicle cabin. As a result, it is possible to ascertain the situation by the visual display, in addition to the additional warning, so the situation (i.e., the situation in which at least one of the doors 2a to 2e is open) is able to be corrected even faster.

What is claimed is:

1. A vehicle warning system comprising:
a detecting portion that is provided on each of a plurality of doors of a vehicle, and detects whether each of the doors is open, including ajar, or closed;
a warning portion that warns that one of the doors is open, when it is detected by the detecting portion that at least one of the doors is open; and
a storing portion that stores information indicating a door type of the door that is detected as being open by the detecting portion, at a point at which the warnings starts, from among the doors, wherein
the warning portion stops the warning and issues an additional warning of a different pattern, according to the door type stored by the storing portion, when any of the doors are opened from a closed state while the warning is being issued.

2. The vehicle warning system according to claim 1, wherein
the warning portion does not stop the warning when a door that accesses a trunk of the vehicle, from among the doors, is opened from a closed state while the warning is being issued.

3. The vehicle warning system according to claim 1, wherein
the warning system warns that one of the doors is open when a lock operation for the doors has been performed on one of the doors, and at least one of the doors is detected as being open by the detecting portion.

4. The vehicle warning system according to claim 3, wherein
the warning portion issues the additional warning in a warning pattern corresponding to the door type stored by the storing portion, from among preset warning patterns corresponding to door types of the doors, when the door type stored by the storing portion is just one door type.

5. The vehicle warning system according to claim 4, wherein
the warning portion issues the additional warning in a warning pattern corresponding to the door type of a door that accesses a trunk of the vehicle, from among the preset warning patterns, when the door type stored by the storing portion is a plurality of door types, and the door type of the door that accesses the trunk is among the door types stored by the storing portion.

6. The vehicle warning system according to claim 5, wherein
the warning portion does not perform the additional warning when the number of door types stored by the storing portion is equal to or greater than a predetermined number that is equal to or greater than two, and the door type of the door that accesses the trunk is not among the door types stored by the storing portion.

7. The vehicle warning system according to claim 6, wherein
the warning portion issues the additional warning in a warning pattern corresponding to the door type of a door positioned on a side opposite the door for which the lock operation has been performed, from among the preset warning patterns, when the door type stored by the storing portion is a plurality of door types, and the number thereof is less than the predetermined number, and the door type of the door that accesses the trunk is not among the door types stored by the storing portion, and the lock operation has been performed for a door provided on a driver side or a passenger side.
